(19) United States
(12) Patent Application Publication
(10) Pub. No.: US 2024/0155283 A1
(43) Pub. Date: May 9, 2024

(54) Set of Headphones

(71) Applicant: Areal BV, Wuustwezel (BE)

(72) Inventors: Pieter Doms, Wuustwezel (BE); Arno Voortman, Overmere (BE)

(21) Appl. No.: 18/548,994

(22) PCT Filed: Mar. 10, 2022
(86) PCT No.: PCT/EP2022/056124

§ 371 Date: Sep. 5, 2023

(30) Foreign Application Priority Data
Mar. 10, 2021 (BE) BE2021/5179

(51) Int. Cl. H04R 1/22; H04R 1/10

(52) U.S. Cl. CPC H04R 1/22; H04R 1/1008

(57) ABSTRACT

The present invention relates to a set of headphones comprising 2 ear cups, wherein each ear cup comprises drivers of varying size connected to a separate feed each. The present invention also relates to a method for processing a set of headphones. The present invention also relates to the use of a set of headphones.

### FIELD OF THE INVENTION

The present invention relates to a set of headphones. The present invention also relates to a method for processing a set of headphones. The present invention also relates to the use of a set of headphones.

### BACKGROUND OF THE INVENTION

Currently, the market of immersive and/or surround headphones basically comprises two main segments.

The largest segment is based on 8D or binaural systems. Binaural systems aim to simulate reality. By using a digital model that adds differences in volume, time, and/or colour to simulated sound in both ears, a sense of direction is created. The most used model is the Kemar model, which is based on an artificial head with average size and shape. However, because each head and/or pair of ears is unique per person (resulting in a unique auditory sense of direction), the results based on an average head will never be 100% satisfactory. This problem may be solved by using Head Related Transfer Functions (HRTFs), which provide a unique digital model of a person's head/ears. By applying adapted software, a more personalised simulation may be provided. However, once a binaural render is made, it cannot be changed to another calculation model. There exist systems that measure an ear to construct an HRTF to use it for converting a 7.1 surround format into a binaural experience. However, such systems are limited to television/movies and require an external device for the computation. Furthermore, if an auditory experience is to be shared among many listeners, providing a specific rendering for each person is simply not feasible. Therefore, any large scale binaural system will always be based on averages.

A second segment uses multiple drivers within one ear cup, and a channel based system to play a surround format. Such headphones are mostly used in the gaming industry, whereby the 7.1 standard is usually used for localisation. The presently existing systems typically use 8 channels which are attributed to one or more drivers in the ear cup. Because these 8 channels are based on specific angles in the listening field and are played on different positions with regards to the ear, the result is not accurate.

Furthermore, such systems typically comprise different drivers of varying sizes, which means that the frequency spectrum cannot be uniformly provided over different segments. Typically, all drivers also have the same angle with respect to the ear, which does not correspond to a realistically accurate sound experience.

U.S. Pat. No. 3,984,885 A describes a structure of four-channel headphones having sound insulating means between front and rear channel driver units, and tone control means only for the front channel tones, said sound insulating means being formed of foam material which transmits low-pitched tones and absorbs high-pitched tones.

US 2006/193481 A1 describes a headset with an active crossover network. The headset is coupled to an audio source using either a wired connection or a wireless connection.

US 2017/332186 A1 describes a method to calibrate earphones includes determining a Head Related Transfer Functions (HRTF) corresponding to different parts of a user's anatomy (e.g., one or both of a listener's pinnae).

U.S. Pat. No. 9,918,154 B2 describes a tactile vibration driver for use in a headphone includes a support structure, at least one suspension member suspending at least one rigid member relative to the support structure, and a plurality of magnetic members attached to the at least one rigid member and configured to drive oscillating movement of the at least one rigid member and the at least one suspension member so as to produce tactile vibrations during operation of the tactile vibration driver.

Therefore, there is a need for headphones that allows for a more realistic auditory experience. There is a need for headphones that allows for a less deformed signal. There is a need for headphones that allows reducing the volume. There is a need for headphones that are less tiring to listen to. There is a need for headphones that lower the risk of hearing damage.

### SUMMARY OF THE INVENTION

In order to meet one or more of the abovementioned needs, the inventors have developed a set of headphones and a method for processing a set of headphones.

Advantages of this set of headphones and the method according to the invention, as well as of embodiments thereof, are described herein.

More in particular the present invention relates to a set of headphones, comprising 2 ear cups, wherein each ear cup comprises drivers of varying size connected to a separate feed each, each ear cup comprising:
at least 1 main driver; and,
at least 2 auxiliary drivers with a diameter that is smaller than the diameter of the main driver. Most preferably, the at least 2 auxiliary drivers are positioned at an angle compared to the plane defined by the at least 1 main driver. Most preferably, the main driver comprises a filter configured to select a range of low frequency sound waves below a lower cut-off frequency f_{L} and a range of high frequency sound waves above an upper cut-off frequency f_{U}. Most preferably, the at least 2 auxiliary drivers comprise a filter configured to select a range of intermediate frequency sound waves between the lower cut-off frequency f_{L} and the upper cut-off frequency f_{U}.

In some preferred embodiments, the at least 1 main driver is positioned in a central position, and the at least 2 auxiliary drivers are positioned around the at least 1 main driver.

In some preferred embodiments, the headphones are circumaural headphones.

In some preferred embodiments, each ear cup comprises at least 3, preferably at least 4 auxiliary drivers with a diameter that is smaller than the diameter of the main driver.

In some preferred embodiments, the diameter of the at least 1 main driver is at least 25 mm and at most 60 mm, preferably at least 30 mm and at most 55 mm, preferably at least 35 mm and at most 50 mm, for example at least 40 mm and at most 45 mm.

In some preferred embodiments, the diameter of the at least 2 auxiliary drivers is at least 8 mm and at most 24 mm, preferably at least 12 mm and at most 20 mm, for example at least 14 mm and at most 18 mm, for example about 16 mm.

In some preferred embodiments, one or more of the auxiliary drivers are positioned at an angle α with respect to the main driver viewed along the centre ear level (front-back axis), wherein α is at least 5° to at most 30°, preferably from at least 100 to at most 25°, preferably from at least 120 to at most 20°, preferably about 15°.

In some preferred embodiments, one or more of the auxiliary drivers are positioned at an angle 3 with respect to the main driver viewed along the centre ear position (bottom-top axis), wherein β is at least 2° to at most 25°, preferably from at least 5° to at most 20°, preferably from at least 7° to at most 15°, preferably about 10°.

In some preferred embodiments, f_{L} is at least 300 Hz and at most 1000 Hz, preferably at least 350 Hz and at most 800 Hz, preferably at least 400 Hz and at most 700 Hz, preferably at least 450 Hz and at most 600 Hz, for example about 500 Hz.

In some preferred embodiments, f_{U} is at least 5.0 kHz and at most 12.0 kHz, preferably at least 6.0 kHz and at most 11.0 kHz, preferably at least 7.0 kHz and at most 10.0 kHz, preferably at least 8.0 kHz and at most 9.5 kHz, preferably about 9.0 kHz.

In some preferred embodiments, the at least 1 main driver comprises a high-pass filter and a low-pass filter in parallel. In some preferred embodiments, the auxiliary drivers comprise a high-pass filter and a low-pass filter in series. In some preferred embodiments, one or more, preferably all, of the filters of the main driver and auxiliary drivers comprise a linear phase filter.

The present invention also relates to a method for processing a set of headphones according as described herein, and embodiments thereof. The method most preferably comprises the steps of:
filtering a sound signal to select a range of low frequency sound waves below a lower cut-off frequency f_{L} and a range of high frequency sound waves above an upper cut-off frequency f_{U}; and sending it to the main driver; and,
filtering a sound signal to select a range of intermediate frequency sound waves between the lower cut-off frequency f_{L} and the upper cut-off frequency f_{U}; and sending it to an auxiliary driver.

In some preferred embodiments, the sound signal sent to the main driver comprises a delay compared to the sound signals sent to the auxiliary drivers.

The present invention also relates to use of a set of headphones as described herein, and embodiments thereof, or of the method as described herein and embodiments thereof, preferably for gaming or VR, for an exclusive audio experience, and/or for a combined audio/video experience.

Embodiments of the present invention have the advantage that correct localisation is obtained by exciting the ear from the right direction. Embodiments of the present invention have the advantage that they allow for a more realistic auditory experience.

Embodiments of the present invention have the advantage that they allow for a less deformed signal. Embodiments of the present invention have the advantage that they allow reducing the volume. Embodiments of the present invention have the advantage that they are less tiring to listen to. Embodiments of the present invention have the advantage that they lower the risk of hearing damage.

### DESCRIPTION OF FIGURES

The following description of the figures of specific embodiments of the invention is merely exemplary in nature and is not intended to limit the present teachings, their application or uses. Throughout the drawings, the corresponding reference numerals indicate the following parts and features:
100—set of headphones; 101—first ear cup; 102—second ear cup; 111—main driver; 121,122,123,124—auxiliary driver; 150—multi-channel inputs; 151—high pass filter; 152—low pass filter; 153—amplifiers; X—front; X′—back; Y—bottom; Y′—top; X-X′—centre ear level (front-back axis); Y-Y′—centre ear position (bottom-top axis); α—angle of driver(s) compared to main driver viewed along X-X′ axis; β—angle of driver(s) compared to main driver viewed along Y-Y′ axis.

FIG. 1A illustrates a set of headphones comprising two ear cups. FIG. 1B illustrates the layout of one ear cup of a set of headphones according to an embodiment of the invention. FIG. 1C illustrates how each auxiliary driver is aimed towards the centre of the ear, which improves the sense of direction.

FIG. 2 illustrates an alternative configuration comprising 4 auxiliary drivers, wherein there is one driver for each main direction (up, down, front, and rear) of the ear cup.

FIGS. 3A and 3B illustrate a further alternative configuration comprising 2 auxiliary drivers, wherein there is one driver for the front and one driver for the rear of the ear cup.

FIGS. 4A and 4B illustrate a further alternative configuration comprising 3 auxiliary drivers, wherein there are two drivers for the top and one driver for the bottom of the ear cup.

FIG. 5 illustrates an electronics block diagram of the hardware being used in a set of headphones according to an embodiment of the invention.

FIG. 6A illustrates the frequency range in which the auxiliary drivers operate in an embodiment of the invention, while FIG. 6B illustrates the frequency range in which the main driver operates for that same embodiment.

FIG. 7 shows a block diagram of the design of the filters to create the ranges in which both driver types need to operate, according to an embodiment of the invention.

FIG. 8 illustrates the difference between parallel drivers and angular drivers.

FIG. 9 illustrates the magnitude response and the phase response of a low pass filter.

FIG. 10 illustrates comb filtering which may occur when filters are combined without aligning the phase response.

FIG. 11 illustrates the additional use of the spatial mid-range of the main driver, illustrating all 3 ranges in which the main driver may be active.

### DETAILED DESCRIPTION

The present invention will be described with respect to particular embodiments, but the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and description, any of the claimed or described embodiments can be used in any combination.

More in particular the present invention relates to a set of headphones, comprising 2 ear cups, wherein each ear cup comprises drivers of varying size connected to a separate feed each, each ear cup comprising:
at least 1 main driver; and,
at least 2 auxiliary drivers with a diameter that is smaller than the diameter of the main driver. Most preferably, the at least 2 auxiliary drivers are positioned at an angle compared to the plane defined by the at least 1 main driver. Most preferably, the main driver comprises a filter configured to select a range of low frequency sound waves below a lower cut-off frequency f_{L} and a range of high frequency sound waves above an upper cut-off frequency f_{U}. Most preferably, the at least 2 auxiliary drivers comprise a filter configured to select a range of intermediate frequency sound waves between the lower cut-off frequency f_{L} and the upper cut-off frequency f_{U}.

Headphones whereby the frequency spectrum is split up in 2 or more sets (low frequencies and high frequencies) typically comprise spatial drivers for the high frequency range. However, when such high-frequency spatial drivers are positioned at a (sharp) angle, the high frequencies inadequately reach the eardrum, since higher frequencies are less bendable than lower frequencies. This results in a sub-optimal spatial experience and the creation of artefacts. In the present invention, the high frequencies are provided by the main driver, yet the mid-range frequencies still allow for the spatial experience to be obtained. This results in an optimal effect of localisation combined with maximal sound quality.

The present invention relates to a set of headphones, herein also referred to as a headset or a set of earphones.

In some preferred embodiments, the headphones are circumaural headphones. Circumaural headphones may also be known as over-ear headphones. The outside of the headphones may be identical to a common pair of headphones. A set of circumaural headphones typically comprises 2 ear cups. In some embodiments, both ear cups are identical. In some embodiments, the configuration of drivers in both ear cups is identical. In some embodiments, the configuration of drivers in one ear cup is a mirror image of the other.

In some embodiments, the set of headphones comprises an input unit, preferably a configured to handle multichannel inputs, for example selected from: USB-C, RJ45, S/PDIF, optical connector, or HDMI. In some embodiments, the set of headphones comprises a USB-C input. In some embodiments, the set of headphones comprises a wireless system, preferably a wireless system configured to handle multichannel inputs, for example Bluetooth, WiFi, or RF.

In some embodiments, the set of headphones comprises a battery, preferably a rechargeable battery.

In some embodiments, the set of headphones comprises one or more microphones. In some embodiments, the set of headphones comprises a noise-cancelling unit.

In some embodiments, the set of headphones comprises a head tracking unit, for example comprising a gyroscope.

Each ear cup comprises a main driver and multiple auxiliary drivers. The main driver may also be referred to as the larger driver, the central driver, or a combination thereof. The auxiliary drivers may also be referred to as the smaller drivers, spatial drivers, angular drivers, surrounding drivers, or a combination thereof.

In some embodiments, the main driver is a diaphragm driver. In some embodiments, the auxiliary drivers are diaphragm drivers. In some embodiments, the main driver is a moving-coil driver, a dynamic driver, a bone conduction driver, and/or a planar driver.

In some embodiments, the auxiliary drivers are moving-coil drivers, dynamic drivers, and/or MEMS drivers, or a combination thereof.

Because the main driver needs to be able to handle both low as well as high frequencies, the main driver is preferably a full range driver, for example a driver with a range between 20 Hz and 20 kHz. The auxiliary drivers need to only be able to properly handle the intermediate frequencies, so a driver with a more limited frequency response may be used, for example between 500 Hz and 10 kHz.

Preferably, each of the aforementioned drivers has a separate feed, which improves the spatial experience. Therefore, preferably each driver (main and auxiliary) has its own amplifier. For example, if there are 1 larger driver and 4 smaller drivers per ear cup, this leads to 5 channels (and thus 5 amplifiers) per ear cup, or 10 channels (and thus 10 amplifiers) for the entire set of headphones.

It is an advantage of the present invention, and embodiments thereof, that it uses multichannel audio and multiple drivers, which provides a more realistic auditory experience compared to simulations, e.g. binaural simulations.

It is an advantage of the present invention, and embodiments thereof, that by using multiple drivers for multiple segments of the total frequency range, the drivers undergo a less charged load, particularly compared to traditional headphones whereby the entire frequency spectrum is provided by 1 driver. This results in a less deformed signal.

In some preferred embodiments, each ear cup comprises at least 3, preferably at least 4 auxiliary drivers with a diameter that is smaller than the diameter of the main driver.

In some embodiments, each ear cup comprises at least 2 auxiliary drivers, preferably at least 3, preferably 4. In some embodiments, each ear cup comprises at most 24 auxiliary drivers, preferably at most 20, preferably at most 16, preferably at most 12, preferably at most 10, preferably at most 8, preferably at most 6, preferably at most 5, preferably 4. In some embodiments, each ear cup comprises at least 2 to at most 24 auxiliary drivers, preferably at least 2 to at most 20, preferably at least 2 to at most 16, preferably at least 2 to at most 12, preferably at least 3 to at most 10, preferably at least 3 to at most 8, preferably at least 3 to at most 6, preferably at least 3 to at most 5, preferably 4.

In some embodiments, each ear cup comprises exactly 1 main driver.

In some preferred embodiments, the at least 1 main driver is positioned in a central position, and the at least 2 auxiliary drivers are positioned around the at least 1 main driver.

In some embodiments, the horizontal distance between two of the auxiliary drivers is at least 20 mm to at most 60 mm, preferably at least 30 mm to at most 50 mm, for example about 40 mm. In some embodiments, the vertical distance between two of the auxiliary drivers is at least 20 mm to at most 50 mm, preferably at least 25 mm to at most 40 mm, for example about 30 mm. In some embodiments, the absolute distance between two of the auxiliary drivers is at least 20 mm to at most 60 mm, preferably at least 25 mm to at most 50 mm, for example at least 30 mm to at most 40 mm.

In some embodiments, the horizontal distance between the midpoint of the auxiliary drivers and the midpoint of the main driver is at least 0 mm to at most 30 mm, preferably at least 5 mm to at most 25 mm, preferably at least 10 mm to at most 20 mm, for example about 15 mm. In some embodiments, the vertical distance between the midpoint of the auxiliary drivers and the midpoint of the main driver is at least 0 mm to at most 40 mm, preferably at least 5 mm to at most 35 mm, preferably at least 10 mm to at most 30 mm, preferably at least 15 mm to at most 25 mm, for example about 20 mm. In some embodiments, the absolute distance between the midpoint of the auxiliary drivers and the midpoint of the main driver is at least 5 mm to at most 50 mm, preferably at least 10 mm to at most 40 mm, preferably at least 15 mm to at most 30 mm, for example at least 20 mm to at most 25 mm.

The arrangement of auxiliary drivers may be symmetrical with regards to the centre ear level, herein also referred to as the front-back axis, as illustrated in the figures. The arrangement may be symmetrical with regards to the centre ear position, herein also referred to as the bottom-top axis, as illustrated in the figures. The arrangement may be asymmetrical with regards to the centre ear level. The arrangement may be asymmetrical with regards to the centre ear position.

Depending on the number of auxiliary drivers, the arrangement of auxiliary drivers may form a triangle (for example an isosceles or equilateral triangle), a quadrilateral (for example a rectangle, diamond, or square), a (regular) pentagon, or a (regular) hexagon. As used herein, the terms “smaller” and “larger” refer to the relative size of the drivers. It is understood that auxiliary drivers have a diameter that is smaller than the diameter of the main driver; and conversely that the diameter of the main driver is larger than the diameter of the auxiliary drivers. Furthermore, the diameter of a driver is preferably suitable to adequately emit the desired frequencies. The diameter of the main driver is preferably large enough to properly emit the low frequencies, yet still fit inside the ear cup.

In some embodiments, the diameter of the at least 1 main driver is at least 25 mm, preferably at least 30 mm, preferably at least 35 mm, for example at least 40 mm. In some embodiments, the diameter of the at least 1 main driver at most 60 mm, preferably at most 55 mm, preferably at most 50 mm, for example at most 45 mm. In some preferred embodiments, the diameter of the at least 1 main driver is at least 25 mm and at most 60 mm, preferably at least 30 mm and at most 55 mm, preferably at least 35 mm and at most 50 mm, for example at least 40 mm and at most 45 mm.

The diameter of the auxiliary drivers is preferably large enough to properly emit the intermediate frequencies, yet still fit inside the ear cup. The auxiliary drivers may all have the same diameter, or may differ in size. Preferably, they have the same diameter.

In some embodiments, the diameter of the at least 2 auxiliary drivers is at least 8 mm, preferably at least 12 mm, for example at least 14 mm. In some embodiments, the diameter of the at least 2 auxiliary drivers is at most 24 mm, preferably at most 20 mm, for example at most 18 mm. In some preferred embodiments, the diameter of the at least 2 auxiliary drivers is at least 8 mm and at most 24 mm, preferably at least 12 mm and at most 20 mm, for example at least 14 mm and at most 18 mm, for example about 16 mm.

While in the prior art the drivers are usually positioned to provide sound waves in the same direction, perpendicular to the ear, the present angular position improves the sense of direction. The inventors have surprisingly found that these specific angles also improve the sound experience and provide a more natural sound. The inventors have surprisingly found that filtering the separate feeds in a particular way also removes any unpleasant artefacts caused by the angular positioning.

It is therefore an advantage of the present invention, and embodiments thereof, that the drivers in the ear cup allow for the sound waves to approach the ear canal from the right angle, which provides for a more realistic and pleasurable auditory experience.

Positioning drivers at an angle may result in unpleasant artefacts. However, the inventors have surprisingly found that if the main driver combines low frequency and high frequency sound waves, while the auxiliary drivers comprise intermediate frequency sound waves, such unpleasant artefacts can be avoided and the overall sound quality is improved.

As used herein, the angles α and β are defined as the angle of an auxiliary driver with respect to the main driver or with respect to the ear cup. The main driver will typically be positioned in the same plane as the ear cup, perpendicular to the ear.

The angle α is defined as the angle that is seen when viewed along the centre ear level (front-back axis), as demonstrated in the figures. The angle α typically defines auxiliary drivers positioned at the bottom or top of the ear cup.

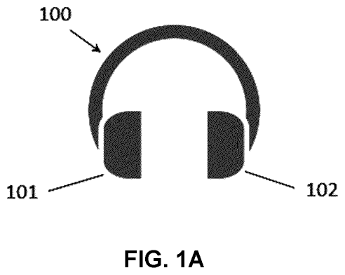

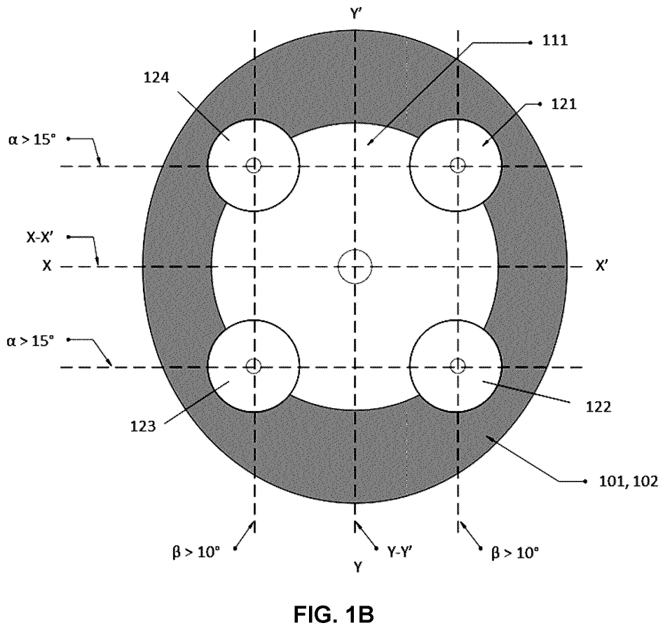

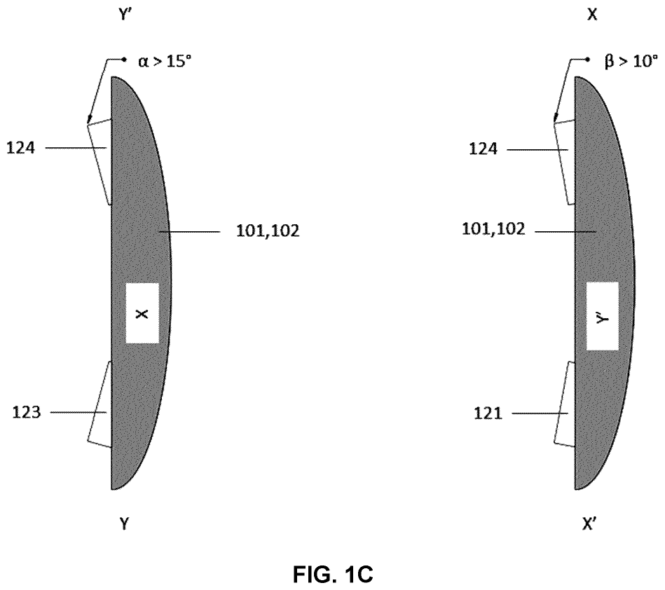

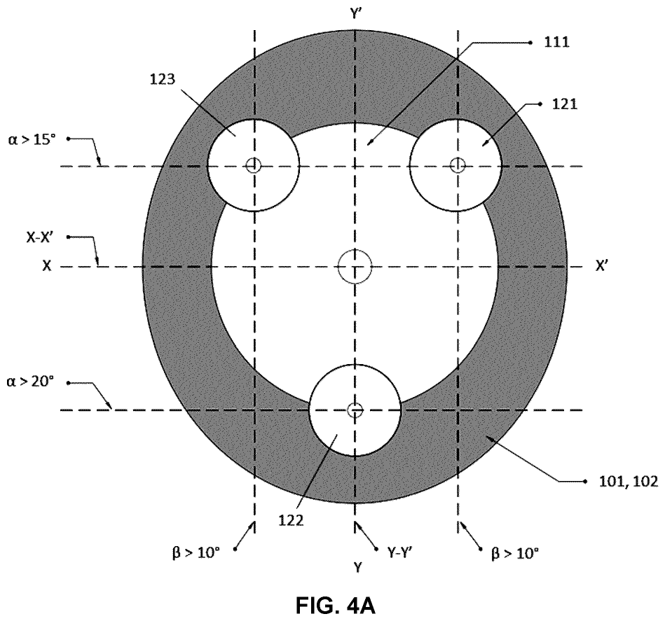

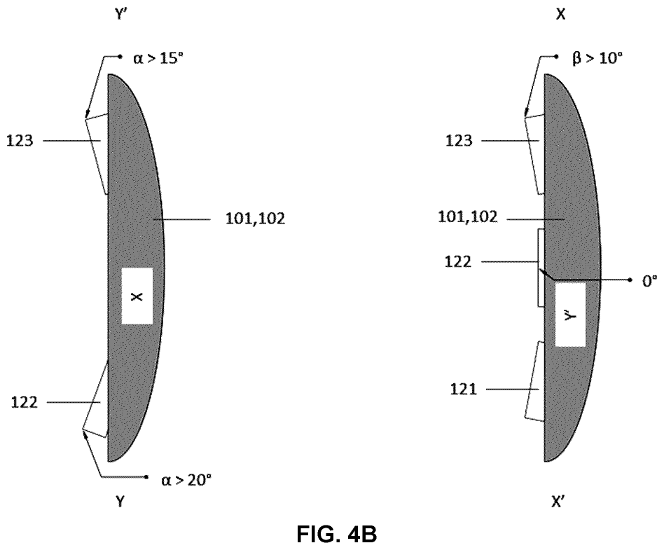

The angle α is illustrated in FIGS. 1C and 4B. Positive values of the angle α refer to the angle of the auxiliary drivers pointing towards the main driver, while negative values of the angle α would refer to the angle of the auxiliary drivers pointing away from the main driver. Preferably, the angle α is positive and the auxiliary drivers are angled towards the main driver, as illustrated in FIGS. 1C and 4B.

The angle β is defined as the angle that is seen when viewed along the centre ear position (bottom-top axis), as demonstrated in the figures. The angle β typically defines auxiliary drivers positioned at the front or back of the ear cup.

The angle β is illustrated in FIGS. 1C, 3B and 4B. Positive values of the angle β refer to the angle of the auxiliary drivers pointing towards the main driver, while negative values of the angle β would refer to the angle of the auxiliary drivers pointing away from the main driver. Preferably, the angle β is positive and the auxiliary drivers are angled towards the main driver, as illustrated in FIGS. 1C, 3B and 4B.

The angles α and/or β may be dependent on the distance between the midpoint of the auxiliary drivers and the midpoint of the main driver. The further away the auxiliary driver is positioned, the larger the angle α and P preferably are.

In some embodiments, one or more of the auxiliary drivers, preferably auxiliary drivers positioned at the top or bottom of the ear cup, are positioned at an angle α with respect to the main driver viewed along the centre ear level (front-back axis), wherein a is at least 5°, preferably at least 10°, preferably at least 12°, preferably about 15°. In some embodiments, α is at most 30°, preferably at most 25°, preferably at most 20°, preferably about 15°. In some preferred embodiments, α is from at least 5° to at most 30°, preferably from at least 100 to at most 25°, preferably from at least 120 to at most 20°, preferably about 15°.

In some embodiments, one or more of the auxiliary drivers, preferably auxiliary drivers positioned at the front or back of the ear cup, are positioned at an angle β with respect to the main driver viewed along the centre ear position (bottom-top axis), wherein β is at least 2°, preferably at least 5°, preferably at least 7, preferably about 10°. In some embodiments, β is at most 25°, preferably at most 20°, preferably at most 15°, preferably about 10°. In some preferred embodiments, β is from at least 2° to at most 25°, preferably from at least 5° to at most 20°, preferably from at least 7° to at most 15°, preferably about 10°.

In some embodiments, the angle α is limited as described above for the angle β. In some embodiments, the angle β is limited as described above for the angle α.

In some embodiments, the angle α is larger than the angle β. In some embodiments, the angle α is at least 2° larger than the angle β, preferably at least 4° larger, preferably at least 6° larger, preferably at least 8° larger, for example about 100 larger. In some embodiments, the angle α is at most 20° larger than the angle β, preferably at most 160 larger, preferably at most 140 larger, preferably at most 120 larger, for example about 100 larger. In some embodiments, the angle α is from at least 2° larger to at most 200 larger than the angle β, preferably from at least 4° larger to at most 160 larger, preferably from at least 6° larger to at most 140 larger, preferably from at least 8° larger to at most 120 larger, for example about 100 larger.

In some embodiments, the angle β is larger than the angle α, as described above.

In some embodiments, the angle α is equal to the angle β.

It is an advantage of the present invention, and embodiments thereof, that a specific processing is used to differentiate between various segments of the frequency spectrum.

As used herein, the terms low frequency, intermediate frequency, and high frequency sound waves are relative terms. It is understood that the high frequency soundwaves have a frequency that is higher than the intermediate frequency sound waves, and that the intermediate frequency soundwaves have a frequency that is higher than the low frequency sound waves.

A low frequency range, for example from 20 Hz to 500 Hz, corresponds to a range of frequencies which the human brain finds difficult to localise. This frequency range can thus be covered by the main driver, which is preferably configured in a central position.

The main driver also has a larger diameter than the auxiliary drivers, which allows it to optimally provide low frequencies.

An intermediate frequency range, for example from 500 Hz to 9 000 Hz, corresponds to a range of frequencies that the human brain uses to localise sound. The angled auxiliary drivers that emit these frequencies allow a user to optimally localise sounds.

A high frequency range, for example from 9 000 Hz tot 20 000 Hz, is important to provide an “open” or “fresh” sound experience. Because of the short wavelength and corresponding low energy, these frequencies are difficult to capture under an angle, since they are difficult to bend into the ear cavity. The main driver provides a direct point of entry for these frequencies to be fully appreciated.

As used herein, the term “cut-off frequency” may also be referred to as corner frequency, or break frequency. As used herein, the cut-off frequency is defined as the −3 dB point.

In some embodiments, the slope at the cut-off frequency is at least 6 dB per octave, preferably at least 12 dB, for example about 24 dB per octave. In some embodiments, the slope at the cut-off frequency is at most 48 dB per octave, preferably at most 36 dB per octave, for example about 24 dB per octave. In some embodiments, the slope at the cut-off frequency is at least 6 dB per octave and at most 48 dB per octave, preferably at least 12 dB per octave and at most 36 dB per octave, for example about 24 dB per octave. As used herein, the term “lower cut-off frequency” or f_{L} refers to the cut-off frequency between the low frequencies and the intermediate frequencies. As used herein, the term “upper cut-off frequency” or f_{U} refers to the cut-off frequency between the intermediate frequencies and the high frequencies.

It is to be understood that the main driver operates below the lower cut-off frequency f_{L} and above the upper cut-off frequency f_{U}, while the auxiliary drivers operate between the lower cut-off frequency f_{L} and the upper cut-off frequency f_{U}.

The inventors have surprisingly found that if the main driver combines low frequency and high frequency sound waves, while the auxiliary drivers comprise intermediate frequency sound waves, unpleasant artefacts can be avoided and the overall sound quality is improved.

In some embodiments, f_{L} is at least 300 Hz, preferably at least 350 Hz, preferably at least 400 Hz, preferably at least 450 Hz, for example about 500 Hz. In some embodiments, f_{L} is at most 1000 Hz, preferably at most 800 Hz, preferably at most 700 Hz, preferably at most 600 Hz, for example about 500 Hz. In some preferred embodiments, f_{L} is at least 300 Hz and at most 1000 Hz, preferably at least 350 Hz and at most 800 Hz, preferably at least 400 Hz and at most 700 Hz, preferably at least 450 Hz and at most 600 Hz, for example about 500 Hz.

In some embodiments, f_{U} is at least 5.0 kHz, preferably at least 6.0 kHz, preferably at least 7.0 kHz, preferably at least 8.0 kHz, preferably about 9.0 kHz. In some embodiments, f_{U} is at most 12.0 kHz, preferably at most 11.0 kHz, preferably at most 10.0 kHz, preferably at most 9.5 kHz, preferably about 9.0 kHz. In some preferred embodiments, f_{U} is at least 5.0 kHz and at most 12.0 kHz, preferably at least 6.0 kHz and at most 11.0 kHz, preferably at least 7.0 kHz and at most 10.0 kHz, preferably at least 8.0 kHz and at most 9.5 kHz, preferably about 9.0 kHz.

Preferably, f_{L} and f_{U} are exactly the same for each of the main drivers and the auxiliary drivers, though there may be some margin of error between the drivers. Preferably, the difference is 0 Hz or close thereto.

In some embodiments, the difference between f_{L} for each driver is at most 20.0%, preferably at most 10.0%, preferably at most 5.0%, preferably at most 2.0%, preferably at most 1.0%, for example at most 0.5%, for example at most 0.2%, for example at most 0.1%. In some embodiments, the difference between f_{L} for each driver is at most 100 Hz, preferably at most 50 Hz, preferably at most 20 Hz, preferably at most 10 Hz, preferably at most 5 Hz, for example at most 2 Hz, for example at most 1 Hz.

In some embodiments, the difference between f_{U} for each driver is at most 20.0%, preferably at most 10.0%, preferably at most 5.0%, preferably at most 2.0%, preferably at most 1.0%, for example at most 0.5%, for example at most 0.2%, for example at most 0.1%. In some embodiments, the difference between f_{U} for each driver is at most 1000 Hz, preferably at most 500 Hz, preferably at most 200 Hz, preferably at most 100 Hz, preferably at most 50 Hz, for example at most 20 Hz, for example at most 10 Hz.

In some preferred embodiments, the at least 1 main driver comprises a high-pass filter and a low-pass filter in parallel. In some preferred embodiments, the auxiliary drivers comprise a high-pass filter and a low-pass filter in series.

In some embodiments, preferably wherein de main driver has a central position in the ear cup, the main driver comprises a separate (additional) channel comprising a filter configured to select a range of intermediate frequency sound waves between the lower cut-off frequency f_{L} and the upper cut-off frequency f_{U}. This allows the main driver to act as an additional spatial driver, improving the sound quality and perception.

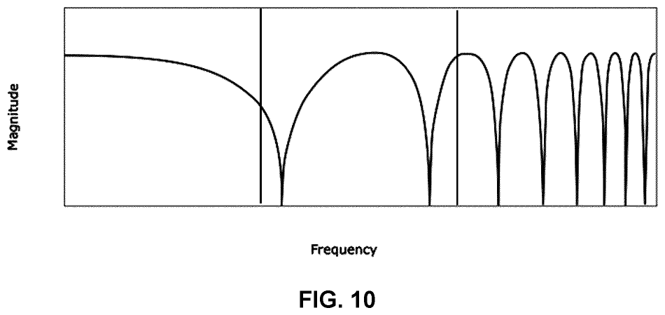

The present set of headphones uses angular drivers to improve the sense of direction towards the ear. Since angular drivers are impossible to align over a certain distance there is no possibility to align the phase response of the high and low pass filters used in the headphones. However, not aligning the phase response of the drivers may result in a side effect known as comb filtering, as illustrated in FIG. 10. The audible effect of comb filtering may be described as unpleasant.

In some preferred embodiments, one or more, preferably all, of the filters of the main driver and auxiliary drivers comprise a linear phase filter. This has been surprisingly found to allow for a further reduction of unpleasant artefacts caused by the angular setting.

It is an advantage of embodiments of the present invention that by using linear phase crossover filters there is no phase difference between the various drivers. This allows avoiding the comb filter effect, and provides an improved auditory sensation.

The use of linear phase filters also allows using the difference in time between the drivers. This allows delaying the main driver so that the sounds will first arrive in the ear coming from the smaller spatial drivers. Therefore the human brain will focus on those drivers resulting in a better spatial experience.

It is an advantage of the present invention, and embodiments thereof, that by using a processing algorithm that divides a standard stereo signal over the various drivers, a more spatial auditory experience can be delivered. Furthermore, it has been found that music which is more spatial is less tiring to be listened to and/or can be played at a lower volume. This may also reduce the risk of temporary or permanent hearing damage.

The present invention also relates to a method for processing a set of headphones according as described herein, and embodiments thereof. The method most preferably comprises the steps of:
filtering a sound signal to select a range of low frequency sound waves below a lower cut-off frequency f_{L} and a range of high frequency sound waves above an upper cut-off frequency f_{U}; and sending it to the main driver; and,
filtering a sound signal to select a range of intermediate frequency sound waves between the lower cut-off frequency f_{L} and the upper cut-off frequency f_{U}; and sending it to an auxiliary driver.

In some preferred embodiments, the sound signal sent to the main driver comprises a (small) delay compared to the sound signals sent to the auxiliary drivers. This delay allows for the user's brain to focus on the smaller spatial drivers, and improves the sense of direction. By introducing a small delay, the auditory signals coming from an angle which reach the brain first, these sounds will be considered as primary, which results in an improved perception of localisation. The secondary signals which arrive slightly later will be merged with the primary signals by the human brain, which is perfectly capable of merging sounds within a limited margin, also known as the Haas effect.

The delay is preferably at least 0.01 ms, preferably at least 0.02 ms, preferably at least 0.05 ms, preferably at least 0.10 ms, for example at least 0.20 ms. The delay is preferably at most 20.0 ms, preferably at most 10.0 ms, preferably at most 5.0 ms, preferably at most 2.0 ms, preferably at most 1.0 ms, for example at most 0.50 ms, for example at most 0.30 ms.

In some embodiments, the polarity of one or more, for example all, auxiliary drivers is reversed in comparison to the main driver. In some embodiments, the polarity of one or more auxiliary drivers is reversed in comparison to one or more other auxiliary drivers. The method of the present invention and embodiments thereof, has the advantage that it is preferably performed as an object based method instead of being a channel based method.

In channel based audio, the multiple channels are directly assigned to one specific sound source. The ratio of virtual sources to sound sources is fixed when the mix is created. This means that the system on which the sound is played needs to exactly match the system for which the mix was created. This may result in a subpar sound experience.

In object based audio, no reference is made to fixed channels and fixed positions, but one uses virtual sources with individual spatial information. The ratio of virtual sources to sound sources is only computed at then side of the end user. This computation depends on the system of the end user. By using such a technique, the created mix is optimally provided to the end user.

In some embodiments, a computational model is used to allow a channel to come from a certain angle. For example, the centre channel of a surround movie may be broadcast by at least 2 drivers. However, the ratio of volumes of the drivers may be adapted in such a way that the human brain perceives the incoming sound as central.

In some embodiments, the method is a computer-implemented method. In some embodiments, the computer-implemented method uses panning, for example vector base amplitude panning (VBAP) or vector base intensity panning (VBIP).

To optimise the possibility of localising the different sources, the computational model uses ILD (interaural level difference) in combination with ITD (interaural time difference). This means that panning is not only achieved by a ratio of volume but also by a ratio of time.

The present invention also relates to use of a set of headphones as described herein, and embodiments thereof, or of the method as described herein and embodiments thereof, preferably for gaming or VR, for an exclusive audio experience, and/or for a combined audio/video experience.

The present invention also relates to the use of a headphone or method as described herein for gaming or VR (virtual reality).

The present invention also relates to the use of a headphone or method as described herein for an exclusive audio experience, such as listening to music or sounds.

The present invention also relates to the use of a headphone or method as described herein for a combined audio/video experience, such as watching a movie or concert.

### EXAMPLES

To better illustrate the properties, advantages and features of the present invention some preferred embodiments are disclosed as examples with reference to the enclosed figures. However, the scope of the present invention is by no means limited to the illustrative examples described below.

### Example 1: Possible Configurations

FIG. 1A illustrates a set of headphones (100) comprising two ear cups (101,102).

FIG. 1B illustrates the layout of one ear cup (101,102) of a set of headphones according to an embodiment of the invention. It shows a preferred position of 4 auxiliary drivers (121,122,123,124) which act as spatial drivers. The centre of the cup comprises a large diaphragm driver as main driver (111). Each driver is fed by a unique signal. Using object based audio processing, different sources can be virtually positioned in space. Software calculates each signal that is sent to each driver to result in the correct spatial experience.

FIG. 1C illustrates how each auxiliary driver (121,123,124) is aimed towards the center of the ear, which improves the sense of direction. The large main driver is preferably at 0° aimed directly to the ear. As viewed along the centre ear level, the top and bottom drivers (123,124) are preferably provided at an angle α that is larger than 15°. As viewed along the centre ear position, the back and front drivers (121,124) are preferably provided at an angle β that is larger than 10°.

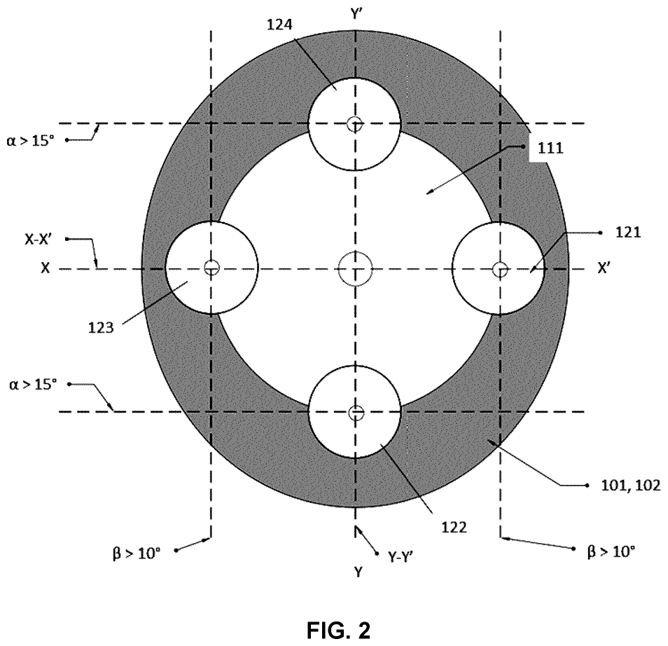

FIG. 2 illustrates a preferred alternative configuration comprising 4 auxiliary drivers (121,122,123,124), wherein there is one driver for each main direction (up, down, front, and rear) of the ear cup. As viewed along the centre ear level, the top and bottom drivers (122,124) are preferably provided at an angle α that is larger than 15°. As viewed along the centre ear position, the back and front drivers (121,123) are preferably provided at an angle β that is larger than 10°.

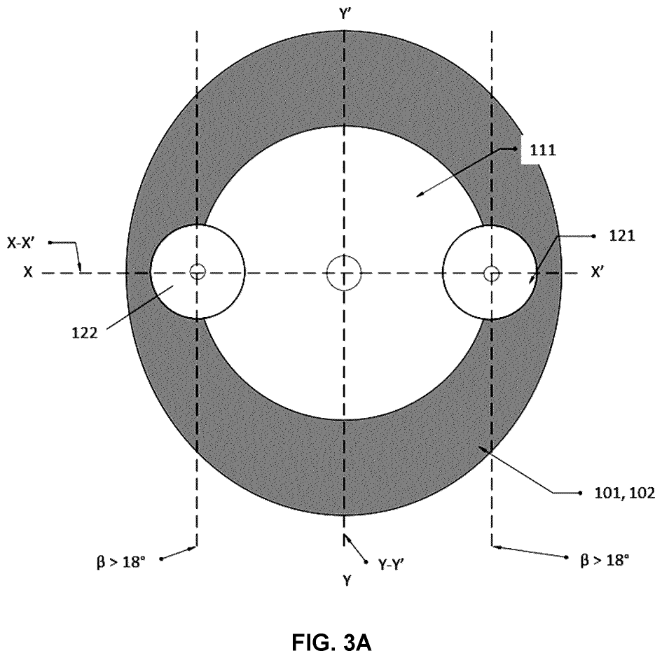

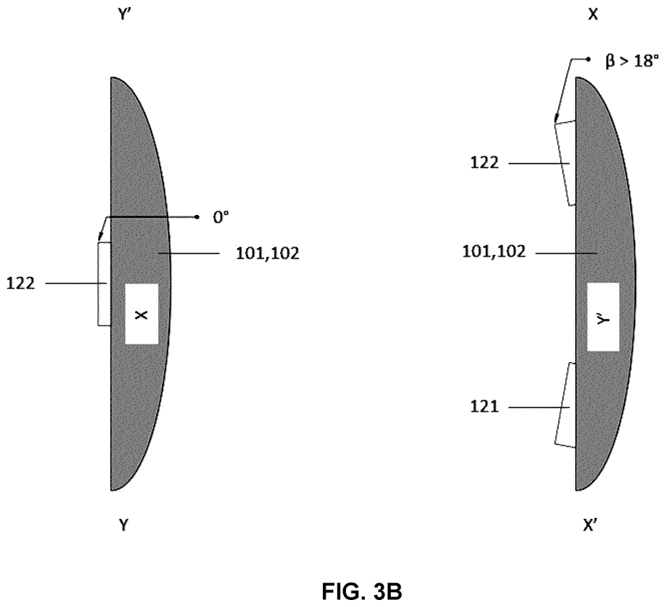

FIGS. 3A and 3B illustrate a further alternative configuration comprising 2 auxiliary drivers (121,122), wherein there is one driver for the front and one driver for the rear of the ear cup (101,102). As viewed along the centre ear level, the back and front drivers (121,122) are preferably in the same plane as the main driver, i.e. provided at an angle α that is equal to 0°. As viewed along the centre ear position, the back and front drivers (121,122) are preferably provided at an angle β that is larger than 18°.

FIGS. 4A and 4B illustrate a further alternative configuration comprising 3 auxiliary drivers (121,122,123), wherein there are two drivers for the top and one driver for the bottom of the ear cup (101,102). As viewed along the centre ear level, the back and front drivers (121,123) situated at the top of the ear cup are provided at an angle α that is larger than 15°, while the bottom driver (122) is provided at an angle α that is larger than 20°. As viewed along the centre ear position, the back and front drivers (121,123) located at the top of the ear cup are preferably provided at an angle β that is larger than 10°, while the bottom driver (122) is preferably in the same plane as the main driver, i.e. provided at an angle β that is equal to 0°.

### Example 2: Block Schematic

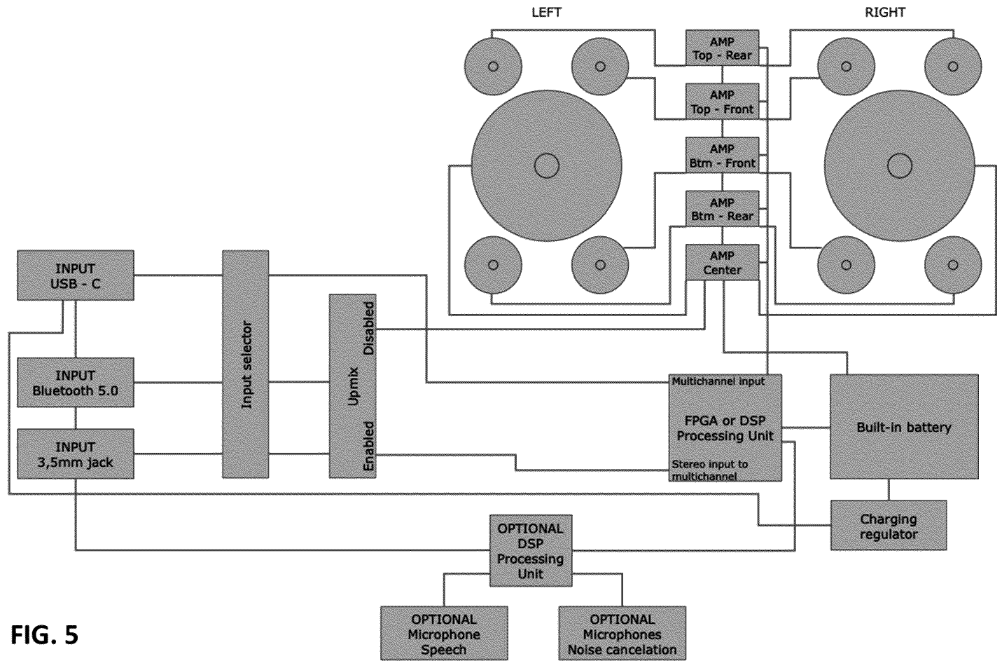

FIG. 5 illustrates an electronics block diagram of the hardware being used in a set of headphones according to an embodiment of the invention. The schematics show the possible inputs which could be selected and the desired processing.

In this example, the only possible multichannel input is dedicated to the USB-C input, since both Bluetooth and 3.5 mm jack are stereo inputs. If so desired, the stereo inputs could be upmixed to a multichannel source.

The schematics also show the presence of a battery being the power source. In this example, this is a rechargeable battery that is being charged by the USB-C connector.

Optionally, microphones may be added. These could be used for speech (e.g. communication during games) or to cancel out the undesired background noise.

### Example 3: Processing

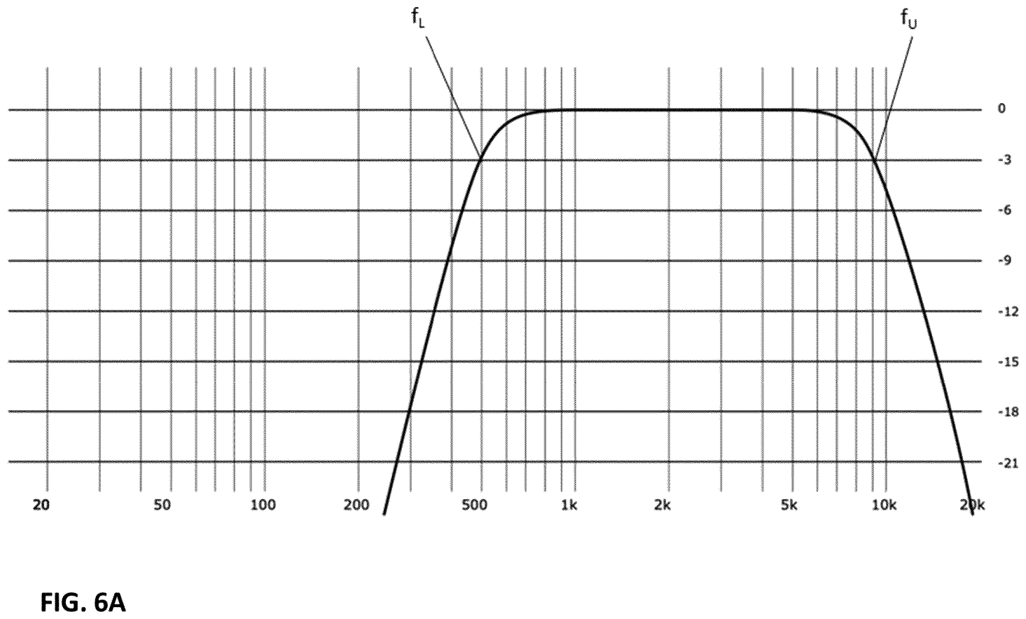

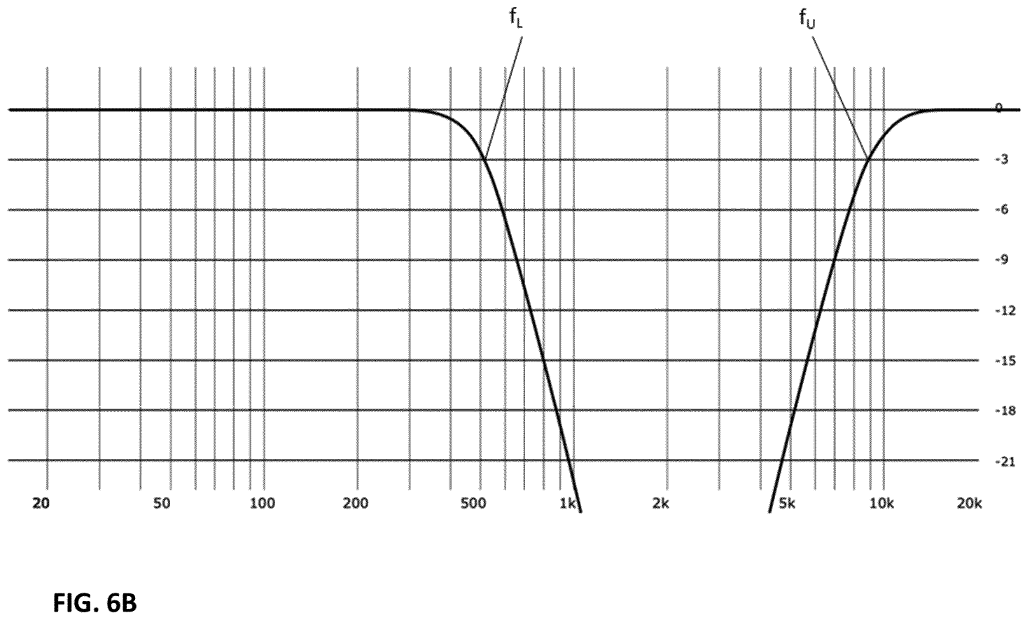

FIG. 6A illustrates the frequency range in which the auxiliary drivers operate in an embodiment of the invention, while FIG. 6B illustrates the frequency range in which the main driver operates for that same embodiment.

Since the spatial experience is only noticeable in a frequency range between about 500 Hz and about 9 kHz this will be the range that is being fed to the spatial drivers. The frequencies below about 500 Hz and above about 9 kHz are being fed to the larger center driver.

The spatial drivers only operate from 500 Hz up to 9 kHz. The filters that are used are 24 dB/octave filters. Since the use of steep filters can create phase shifting between the drivers, the filters are designed to be linear phase filters.

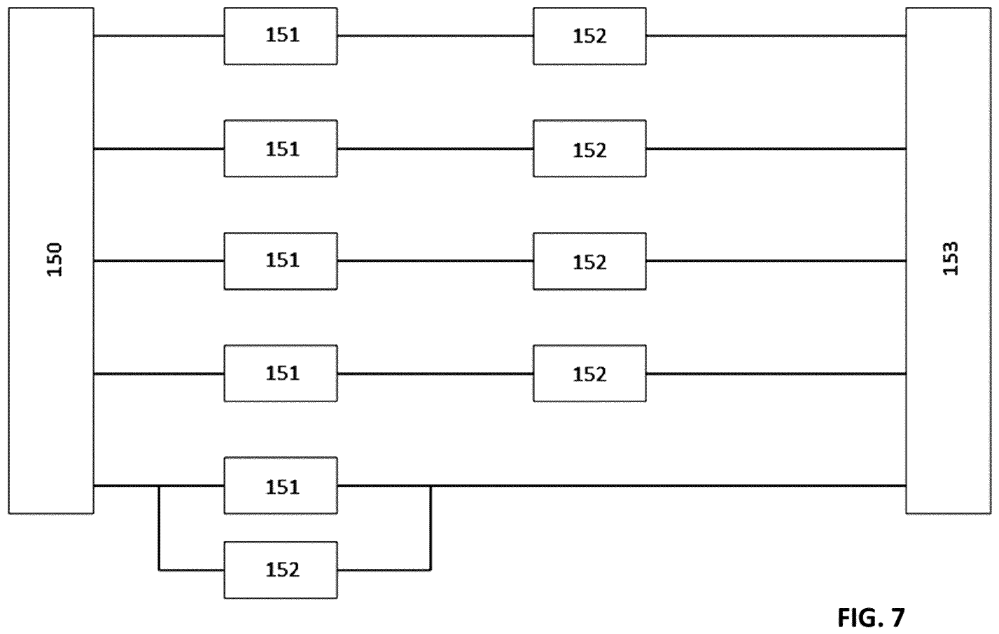

FIG. 7 shows a block diagram of the design of the filters to create the ranges in which both driver types need to operate, according to an embodiment of the invention. The multi-channel inputs (150) are sent to the amplifiers (153) through a high pass filter (151) and a low pass filter (152). The high pass filter (151) and the low pass filter (152) are arranged in series for the auxiliary drivers, and are arranged in parallel for the main driver.

### Example 4: Linear Phase Filters

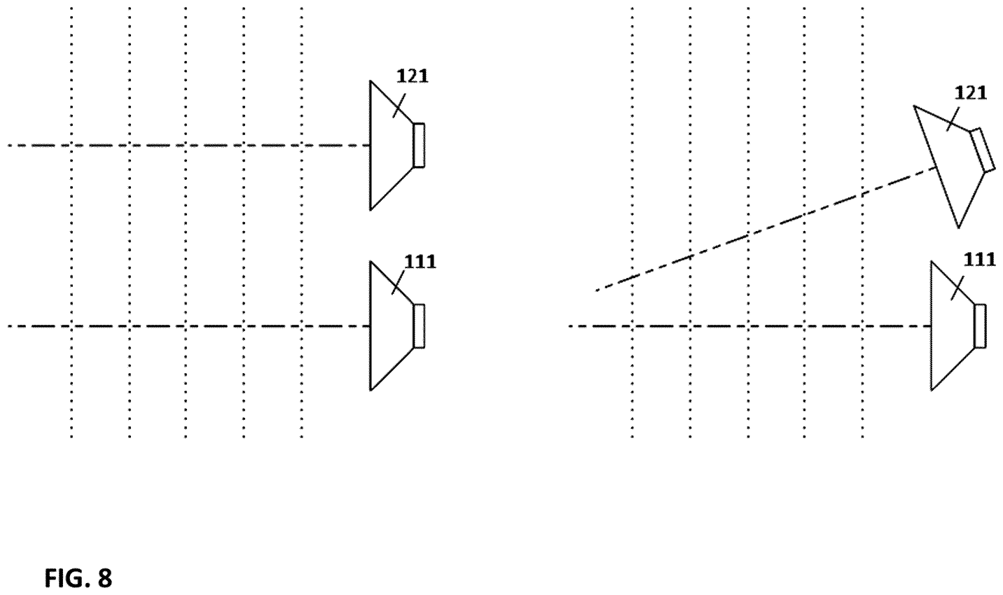

FIG. 8 illustrates the difference between parallel drivers and angular drivers. Over a certain distance the parallel drivers will keep the timing between themselves equal. With the angular drivers, i.e. having an angle between the auxiliary driver (121) and the main driver (111) and/or an angle between two auxiliary drivers, the timing between the drivers varies over distance. Therefore alignment may be difficult to achieve.

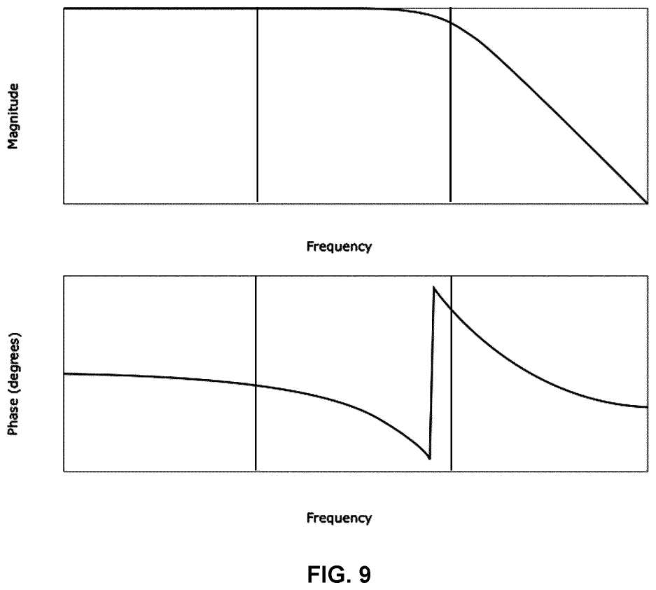

FIG. 9 illustrates the magnitude response and the phase response of a low pass filter. Due to the phase shift that a regular filter produces, it is preferred to align the different filters that are used in the combined drivers. When filters are combined without aligning the phase response comb filtering may occur, as demonstrated in FIG. 10.

To avoid the result of faulty alignment of the phase response, linear phase filters are preferably used. These filters are designed to create a change in amplitude without compromising the phase response. When the phase responses of both drivers are theoretically identical, the angular position between them will no longer result in an undesired comb filter effect, therefore resulting in an improved sound.

### Example 5: User Experiences

Persons A and B were subjected to various types of headphones, as described below.

### Example 5A

Headphones according to an embodiment of the invention were compared to traditional stereo headphones.

Stereo Headphones are headphones which play back distinct sounds from two speakers (left and right speaker), originating from two independent channels (left and right channel) to provide for distinct sounds exiting each speaker. When wearing stereo headphones, each ear can only hear the sound from its own earpiece—there is no natural way in which the sound from the left earpiece can reach the right ear. As a result, the recorded amplitude differences between the left and right channels do not create the required time-of-arrival differences. Consequently, most people perceive sounds coming from inside their heads, spaced roughly on a line running from ear to ear. The reaction of persons A and B was similar, complimenting the clarity, looking for nuances that might happen. During the tests, the subjects noticed that levels increased slowly but surely. Despite the fact that headphone drivers demonstrate a lower distortion than loudspeakers (i.e. more detail and clarity in the mid/high range), the listening level was high.

Persons A and B did not notice any differences to the physical dimensions of the headphones according to an embodiment of the invention other than a thicker cable (beta test purposes). Once program material was played, both A and B noticed what was described as ‘air’ in the mix, and a better positioning of instruments and sounds. Words like ‘resolution’, ‘definition’, and ‘warmth’ were used to describe the higher quality of sound received. As a surplus, in both occasions the overall level (master volume) was turned down by approx. −6 dB. Perceived sounds were not only described as horizontal (aka left to right), but also the dimension height was introduced in the explanation.

### Example 5B

Headphones according to an embodiment of the invention were compared to traditional binaural headphones.

The challenging part of listening through headphones is the impression of stereo positioning, assuming the use of conventional pan-pot amplitude-difference techniques. If one of the more complex panning systems that involves time-of-arrival differences and HRTF functions are used as well, the imaging may translate more easily. In general, though, when listening via headphones, the spatial image will typically be spread along a line running between the ears, and most definitely inside the head. Furthermore, the linearity of the panning proportions is rather different from that experienced on loudspeakers. A generic HRTF profile tested by large research labs and suited to the majority of people was used. Tests revealed that persons A and B definitely could hear the difference between the stereo program material and the binaural. The binaural was perceived as an upgrade of the stereo mix in terms of spatial experience. Unfortunately, the processing techniques and psychoacoustics required for the binaural mix affected the overall sound quality of the music. Both subjects A and B agreed that the original stereo mix felt warmer and was easier to listen to.

When comparing the binaural mix to headphones according to an embodiment of the invention, both subjects A and B happily agreed that the perfect combination was made. The open mix was perceived, the warmth of the original music was maintained, and the unpleasant artefacts which occurred with the binaural processing were eliminated.

### Example 5C

A pair of headphones comprising 4 spatial drivers in a rectangular pattern (FIG. 1B) was compared to a pair of headphones comprising 4 spatial drivers in a diamond pattern (FIG. 2), to define the differences in localisation. Results favoured the diamond layout, since there is a spatial driver in each primary direction (up, down front back). When placing a sound in front of the listener in the rectangular layout, 2 drivers generate the sound, thereby virtually placing the sound between them. In the diamond-shaped configuration, there will be only one driver generating the sound in front of the listener which creates a more defined result. When using a 5.1 or 7.1 surround sound source (both being a 2D surround sound due to the lack of height information) in the rectangular configuration, all 4 drivers need to generate sound to simulate the 2D sound field between them. When using the same file in the diamond-shaped configuration, only the front and back drivers generate sound. This results in a less blurred listening experience and a more defined localisation.

### Example 6: Centre Spatial Channel

In order to increase the amount of spatial drivers in the headphones, the mid-range of the main driver can be used as an additional spatial channel. The centre driver originally only delivers the lower frequencies (e.g. 20 Hz-500 Hz) and the very high frequencies (e.g. 9 kHz-20 kHz), i.e. the frequencies outside the spatial area. However, the unused frequency spectrum of the centre driver (e.g. 500 Hz-9 kHz) may be used as an additional spatial channel in the centre of the ear cup, resulting in a higher resolution of the 3D sound image.

The calculation model which defines the distribution of a sound over the spatial drivers will be more accurate when it has more spatial drivers available for creating the sense of direction in sound. Another benefit of adding a spatial centre channel is that the reciprocal distance between spatial drivers is reduced (typically halved), which results in a higher resolution sound image.

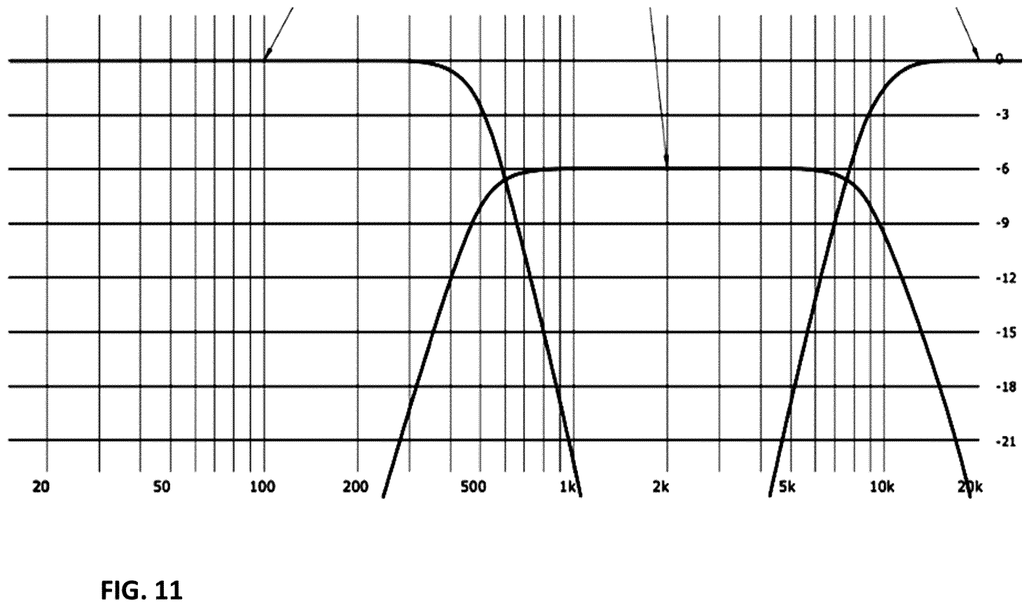

FIG. 11 illustrates the additional use of the spatial mid-range of the main driver, illustrating all 3 ranges in which the main driver may be active. Since the spatial range (e.g. 500 Hz-9 kHz) is represented by multiple spatial drivers, the level generated is lower than the upper and lower frequency regions. Since the design already has an amplifier for the main driver, the addition of a spatial centre channel is purely software/DSP based, and no hardware adjustments are needed.

1. A set of headphones (100), comprising 2 ear cups (101,102), wherein each ear cup (101,102) comprises drivers of varying size connected to a separate feed each, each ear cup comprising:
at least 1 main driver (111); and,
at least 2 auxiliary drivers (121, 122, 123, 124) with a diameter that is smaller than the diameter of the main driver (111);
wherein the at least 2 auxiliary drivers (121, 122, 123, 124) are positioned at an angle compared to the plane defined by the at least 1 main driver (111);
wherein the main driver (111) comprises a filter configured to select a range of low frequency sound waves below a lower cut-off frequency f_{L} and a range of high frequency sound waves above an upper cut-off frequency f_{U}; and,
wherein the at least 2 auxiliary drivers (121, 122, 123, 124) comprise a filter configured to select a range of intermediate frequency sound waves between the lower cut-off frequency f_{L} and the upper cut-off frequency f_{U}.

2. A set of headphones (100) according to claim 1, wherein the at least 1 main driver (111) is positioned in a central position, and wherein the at least 2 auxiliary drivers (121, 122, 123, 124) are positioned around the at least 1 main driver (111).

3. A set of headphones (100) according to any one of the preceding claims, wherein the headphones are circumaural headphones.

4. A set of headphones (100) according to any one of the preceding claims, each ear cup (101,102) comprising at least 3, preferably at least 4 auxiliary drivers (121, 122, 123, 124) with a diameter that is smaller than the diameter of the main driver (111).

5. A set of headphones (100) according to any one of the preceding claims, wherein the diameter of the at least 1 main driver (111) is at least 25 mm and at most 60 mm, preferably at least 30 mm and at most 55 mm, preferably at least 35 mm and at most 50 mm, for example at least 40 mm and at most 45 mm.

6. A set of headphones (100) according to any one of the preceding claims, wherein the diameter of the at least 2 auxiliary drivers (121, 122, 123, 124) is at least 8 mm and at most 24 mm, preferably at least 12 mm and at most 20 mm, for example at least 14 mm and at most 18 mm, for example about 16 mm.

7. A set of headphones (100) according to any one of the preceding claims, wherein one or more of the auxiliary drivers (121, 122, 123, 124) are positioned at an angle α with respect to the main driver (111) viewed along the centre ear level, wherein α is at least 5° to at most 30°, preferably from at least 100 to at most 25°, preferably from at least 120 to at most 20°, preferably about 15°.

8. A set of headphones (100) according to any one of the preceding claims, wherein one or more of the auxiliary drivers (121, 122, 123, 124) are positioned at an angle β with respect to the main driver (111) viewed along the centre ear position, wherein β is at least 2° to at most 25°, preferably from at least 5° to at most 20°, preferably from at least 7° to at most 15°, preferably about 10°.

9. A set of headphones (100) according to any one of the preceding claims, wherein f_{L} is at least 300 Hz and at most 1000 Hz, preferably at least 350 Hz and at most 800 Hz, preferably at least 400 Hz and at most 700 Hz, preferably at least 450 Hz and at most 600 Hz, for example about 500 Hz.

10. A set of headphones (100) according to any one of the preceding claims, wherein f_{U} is at least 5.0 kHz and at most 12.0 kHz, preferably at least 6.0 kHz and at most 11.0 kHz, preferably at least 7.0 kHz and at most 10.0 kHz, preferably at least 8.0 kHz and at most 9.5 kHz, preferably about 9.0 kHz.

11. A set of headphones (100) according to any one of the preceding claims, wherein the at least 1 main driver (111) comprises a high-pass filter (151) and a low-pass filter (152) in parallel; and/or wherein the auxiliary drivers (121, 122, 123, 124) comprise a high-pass filter (151) and a low-pass filter (152) in series.

12. A set of headphones (100) according to any one of the preceding claims, wherein one or more, preferably all, of the filters (151,152) of the main driver (111) and auxiliary drivers (121, 122, 123, 124) comprise a linear phase filter.

13. A method for processing a set of headphones (100) according to any one of the preceding claims, the method comprising the steps of:
filtering a sound signal to select a range of low frequency sound waves below a lower cut-off frequency f_{L} and a range of high frequency sound waves above an upper cut-off frequency f_{U}; and sending it to the main driver (111); and,
filtering a sound signal to select a range of intermediate frequency sound waves between the lower cut-off frequency f_{L} and the upper cut-off frequency f_{U}; and sending it to an auxiliary driver (121, 122, 123, 124).

14. The method according to claim 13, wherein the sound signal sent to the main driver (111) comprises a delay compared to the sound signals sent to the auxiliary drivers (121, 122, 123, 124).

15. Use of a set of headphones (100) according to any one of claims 1 to 12, or of the method according to any one of claim 13 or 14, for gaming or VR, for an exclusive audio experience, and/or for a combined audio/video experience.
